(19) United States
(12) Patent Application Publication
(10) Pub. No.: US 2013/0071173 A1
(43) Pub. Date: Mar. 21, 2013

(54) PIVOT JOINT ARRANGEMENT

(71) Applicant: Johannes STEINDL, Elsbethen (AT)

(72) Inventor: Johannes STEINDL, Elsbethen (AT)

(21) Appl. No.: 13/613,165

(22) Filed: Sep. 13, 2012

(30) Foreign Application Priority Data
Sep. 15, 2011 (EP) 11007519.9

(51) Int. Cl. F16C 11/10

(52) U.S. Cl. 403/91

(57) ABSTRACT

A pivot joint arrangement is provided for a crane arm having a securing device for operating devices. The arrangement has a pivot joint which has two spaced-apart pivot bearings, at least one of the two pivot bearings having at least two flaps and a bearing pin. One flap is connectable to the crane arm and the other flap is connectable to the securing device, and the bearing pin is connected in a rotationally secure manner to one of the two flaps and rotates relative to the other of the two flaps. At least one swing brake brakes or damps an oscillation of the operating device on the crane arm, the swing brake having a plurality of disc-like brake elements.

### BACKGROUND OF THE INVENTION

The present invention relates to a pivot joint arrangement for a crane arm having a securing device for operating devices, having the features of the preamble of claim 1, a crane having such a pivot joint arrangement and a vehicle having such a crane.

A conventional pivot joint arrangement is known, for example, from EP 1 551 748 B1. The pivot joint arrangement set out therein has a swing brake having a total of three brake discs, of which two brake discs are connected in a rotationally secure manner to that portion of the pivot joint arrangement on which those flaps which can be connected to the securing device (lower flaps in the position for use) are also arranged. Furthermore, an additional disc-like brake element is provided which is connected in a rotationally secure manner to that portion of the pivot joint arrangement to which those flaps which are themselves connected to the crane arm (upper flaps in the position for use) are also connected. The disc-like brake elements are placed in the region between the pivot bearings which are arranged so as to be spaced apart from each other.

According to the teaching of EP 1 551 748 B1 (paragraph 11), it is significant that the swing brake is constructed independently of the actual pivot bearings so that the disc-like brake elements can be readily replaced.

The disadvantage of this prior art is that the disc-like brake elements which are taught therein are relatively large, for which reason they must be arranged in the region between the two pivot bearings since sufficient structural height is only available at that location.

A pivot joint arrangement which is not of the generic type is sold by the company Black Bruin. This pivot joint arrangement has only a single pivot bearing having two flaps which are arranged so as to be spaced apart from each other and which are connected to the crane arm (upper flaps in the position for use) and a bearing pin which is arranged between the flaps so as to be rotationally secure therewith and on which the securing device is suspended in an oscillating manner by means of an oscillating eyelet. Therefore, the space between the two flaps is completely filled by the bearing pin and the corresponding oscillating eyelet. At the outer side of the pivot joint arrangement there is secured a swing brake having a plurality of disc-like brake elements of which one portion has an external-toothed arrangement on the outer peripheral edge thereof and the other portion has an internal-toothed arrangement on the inner peripheral edge thereof. The bearing pin has a complementary toothed arrangement by means of which the disc-like brake elements of the portion that have an internal-toothed arrangement can be secured. The disc-like brake elements of the other portion are retained by means of an internal-toothed arrangement which is arranged on an attached ring.

### SUMMARY OF THE INVENTION

An object of the invention is to develop a generic pivot joint arrangement, a crane and a vehicle having a crane in such a manner that the swing brake requires less space.

This object is achieved with a pivot joint arrangement having the features of claim 1, a crane having such a pivot joint arrangement and a vehicle having such a crane.

In contrast to the teaching of EP 1 551 748 B1, therefore, the bearing pin is a significant component of the swing brake since a portion of the disc-like brake elements is secured thereto. However, since this portion of disc-like brake elements from the plurality of disc-like brake elements is connected to the bearing pin only by means of their profiles that allow positive-locking, that is to say, in a manner which can be readily released, it is nonetheless possible to exchange the disc-like brake elements in a relatively problem-free manner.

With respect to the prior art, there is in particular the advantage of a very small spatial requirement. This enables, for example, as in EP 1 889 808 B1 from the Applicant, hose lines which extend from the crane arm to connections on the securing device or on the operating device, to be guided between the pivot bearings in a protected manner.

Other advantageous embodiments of the invention are defined in the dependent claims.

Two embodiments are intended to be emphasised in particular:
the plurality of disc-like brake elements may be arranged at least partially, preferably completely, in the pivot bearing (possible in all embodiments);
the plurality of disc-like brake elements and the plurality of disc springs may be arranged along a common axis (preferably the rotation axis of the pivot joint)—in a manner of speaking in alignment—(possible in those embodiments with disc springs).

The invention is set out by way of example below with reference to various embodiments. For the sake of simplicity, all the embodiments below with positive-locking profiles in the form of toothed arrangements are discussed. Each outer or inner profile (and the respective complementary profiles) which allows positive-locking securing (in addition to the toothed arrangement, for example, also a multi-sided profile) would be able to be used.

### BRIEF DESCRIPTION OF THE DRAWINGS

FIGS. 1 to 4 each show a separate embodiment of the invention, in which FIGS. 1a, 2a, 3a, and 4a show a plan view along an axis at right-angles relative to the axis of rotation of the pivot joint arrangement. FIGS. 1b, 2b, 3b, and 4b show an enlarged cutout with a sectioned illustration, and FIGS. 1c, 2c, 3c, and 4c show an exploded view.

FIG. 5 is a perspective view of a crane arm having a pivot joint arrangement according to the invention.

FIG. 6 shows the arrangement of FIG. 5 with the operating device in the form of a forestry type processing device secured thereto.

### DETAILED DESCRIPTION OF THE INVENTION

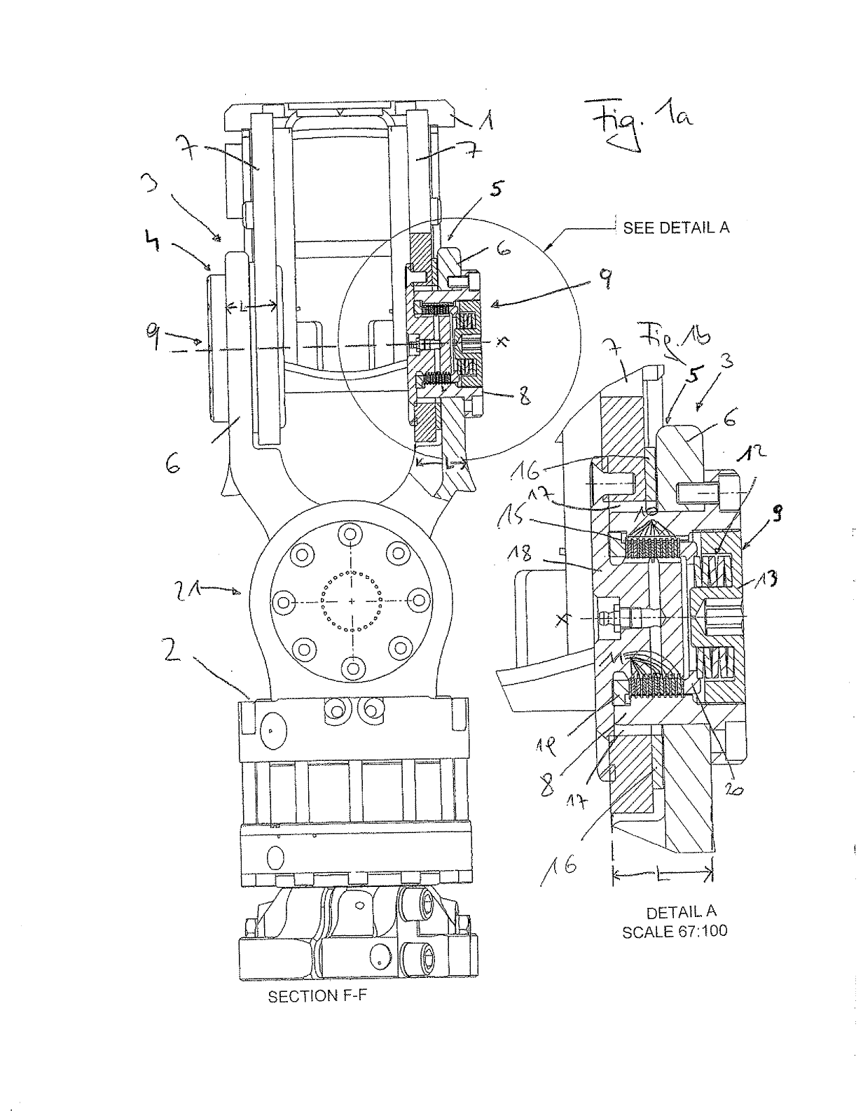

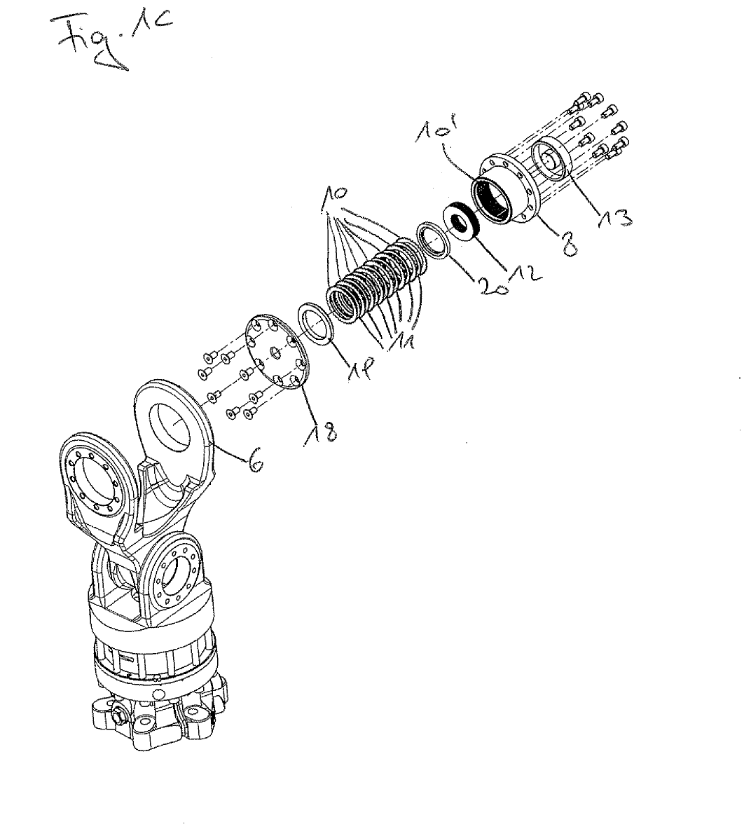

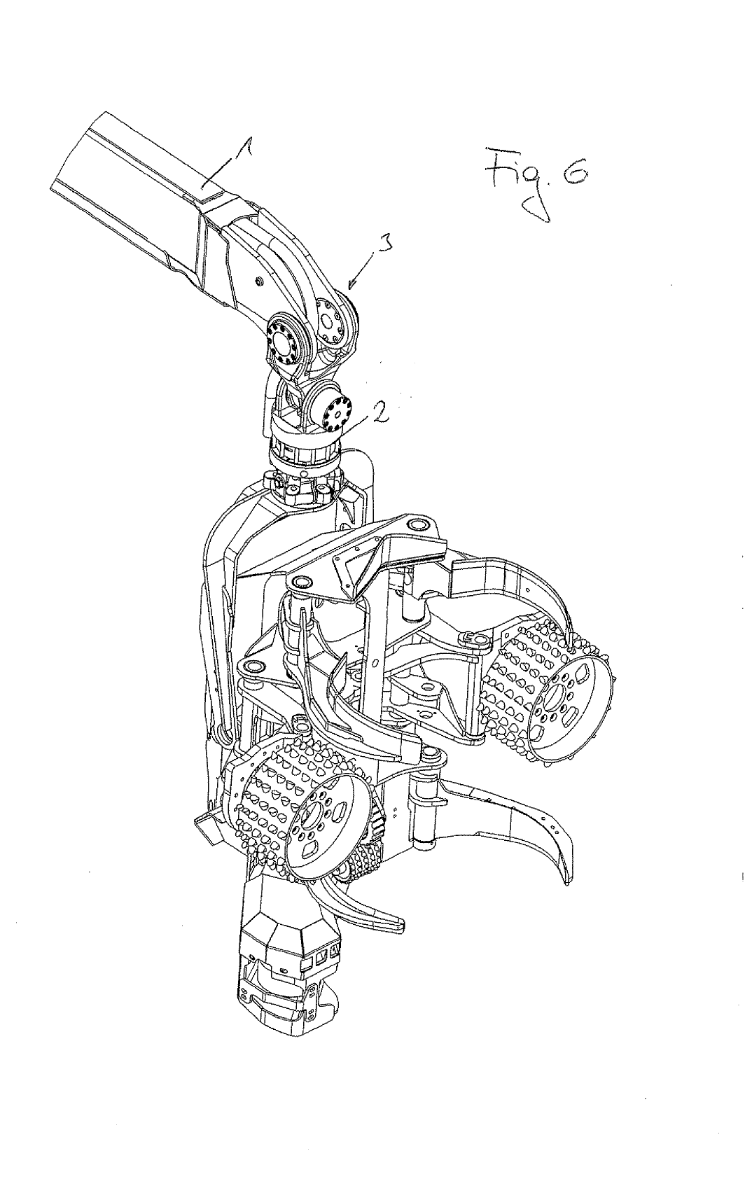

FIG. 1a shows a pivot joint arrangement having a pivot joint 3 which has along the rotation axis x thereof two spaced-apart pivot bearings 4, 5 (extent in each case L along the axis of rotation x). Each of the two pivot bearings 4, 5 has in this instance a flap 7 (in the position for use an upper flap 7) which is connected to the end piece of the crane arm 1 and a flap 6 (a lower flap 6 in the position for use) which is connected to a securing device 2 for a non-illustrated operating device (see FIG. 6).

As can be seen in particular from FIG. 1b, a bearing pin 8 is connected in a rotationally secure manner to the flap 6 by means of a screw type crown (see FIG. 1c). The bearing pin 8 is supported in the flap 7 by means of a bearing ring which is not illustrated in FIG. 1b for reasons of clarity (would be located in the annular recess 17 which extends between the cover 18 and the flap 6). Between the flaps 6, 7 other sliding surfaces 16 are provided to reduce friction.

Oscillation of the securing device 2 and consequently an operating device which is arranged thereon on the crane arm 1 is prevented or damped by means of the swing brake 9.

The swing brake 9 has a plurality 10, 11 of disc-like brake elements, there being provided an adjustable clamping device by means of which the plurality 10, 11 of disc-like brake elements are pressed together with an adjustable compressing force. In the embodiment shown, the clamping device has a plurality 12 of disc springs and a screw mechanism 13 for pressing together the plurality 12 of disc springs. In place of the disc springs, it would also in principle be possible to provide in all embodiments other clamping elements which are mechanical (for example, helical springs) or even hydraulic.

In the embodiment shown, the bearing pin 8 has an axial recess 15. In this recess 15, both the plurality 10, 11 of disc-like brake elements and the plurality 12 of disc springs and the screw mechanism 13 are arranged.

Since the pivot bearing 5 extends between the left end of the flap 7 in FIG. 1b and the right end of the flap 6 (region L), it can be seen that the plurality 10, 11 of disc-like brake elements is completely arranged inside the pivot bearing 5. The plurality 12 of disc springs and the screw mechanism 13 are for the most part arranged outside the pivot bearing 5.

The compressing force of the plurality 12 of disc springs is transmitted by means of an intermediate ring 20 to the plurality 10, 11 of disc-like brake elements. The plurality 10, 11 of disc-like brake elements is supported at the left-hand side in FIG. 1b on the cover 18 by means of a spacer ring 19.

In all the embodiments shown, there is always provision for a portion 10 of the disc-like brake elements from the plurality 10, 11 of disc-like brake elements to have an external-toothed arrangement on the outer peripheral edge thereof and a second portion 11 of the disc-like brake elements from the plurality 10, 11 of disc-like brake elements to have an internal-toothed arrangement on the inner peripheral edge thereof. When viewed in an axial direction, a disc-like brake element having an external-toothed arrangement and a disc-like brake element having an internal-toothed arrangement alternate (but this is not absolutely necessary).

It is sufficient for a brake lining to be arranged on a portion 10, 11 of the disc-like brake elements from the plurality 10, 11 of disc-like brake elements.

When viewed in an axial direction (along the rotation axis x), the plurality 10, 11 of disc-like brake elements and the plurality 12 of disc springs are arranged one behind the other in alignment with reference to the axis of rotation x.

In the embodiment shown, the first portion 10 of disc-like brake elements from the plurality 10, 11 of disc-like brake elements has the external-toothed arrangement and is secured thereto by means of a complementary toothed arrangement 10′ which is arranged on the bearing pin 8. Unlike the illustration, it is not absolutely necessary for the bearing pin 8 itself to have the complementary toothed arrangement 10′. It would be sufficient for a portion which is connected to the bearing pin 8 to have the corresponding complementary toothed arrangement 10′.

The complementary toothed arrangement 11′ for the second portion 11 of disc-like brake elements from the plurality 10, 11 of disc-like brake elements is arranged on the cover 18 (cannot be seen in FIG. 1c).

In the version of FIG. 1a, identically constructed swing brakes 9 are arranged on both pivot bearings 4, 5 of the pivot joint 3. It would be sufficient to arrange a swing brake 9 in only one of the two pivot bearings 4, 5, which swing brake 9 would then optionally have to have more disc-like brake elements and/or more disc springs.

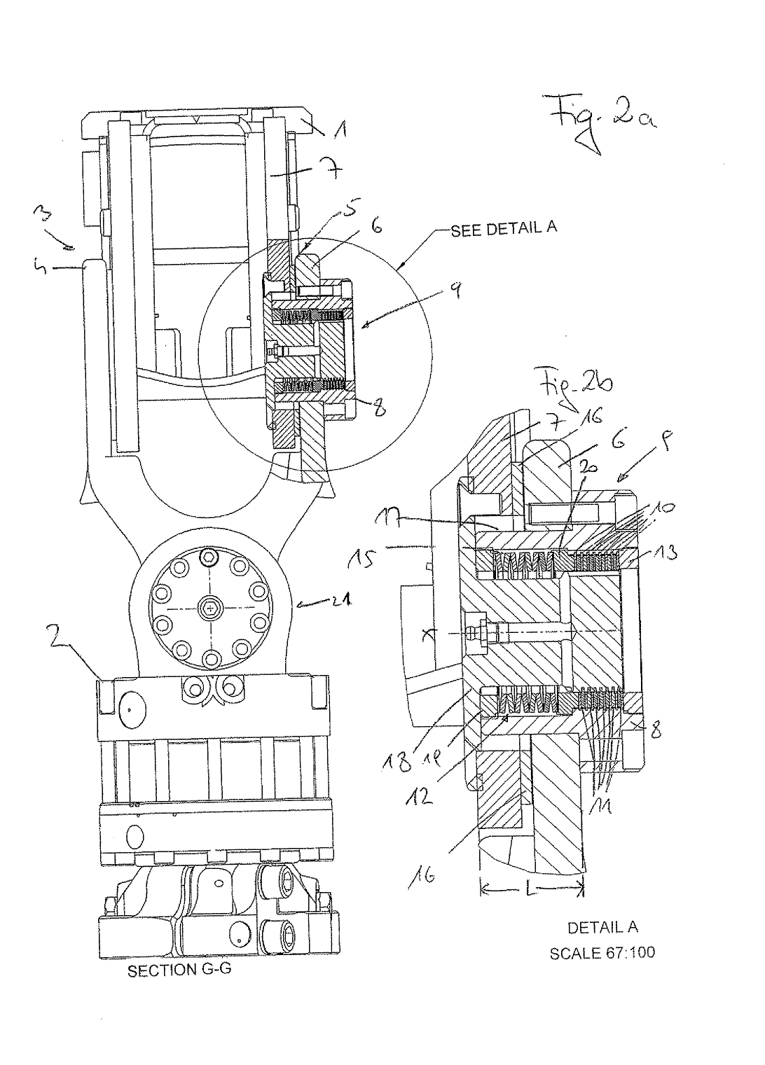

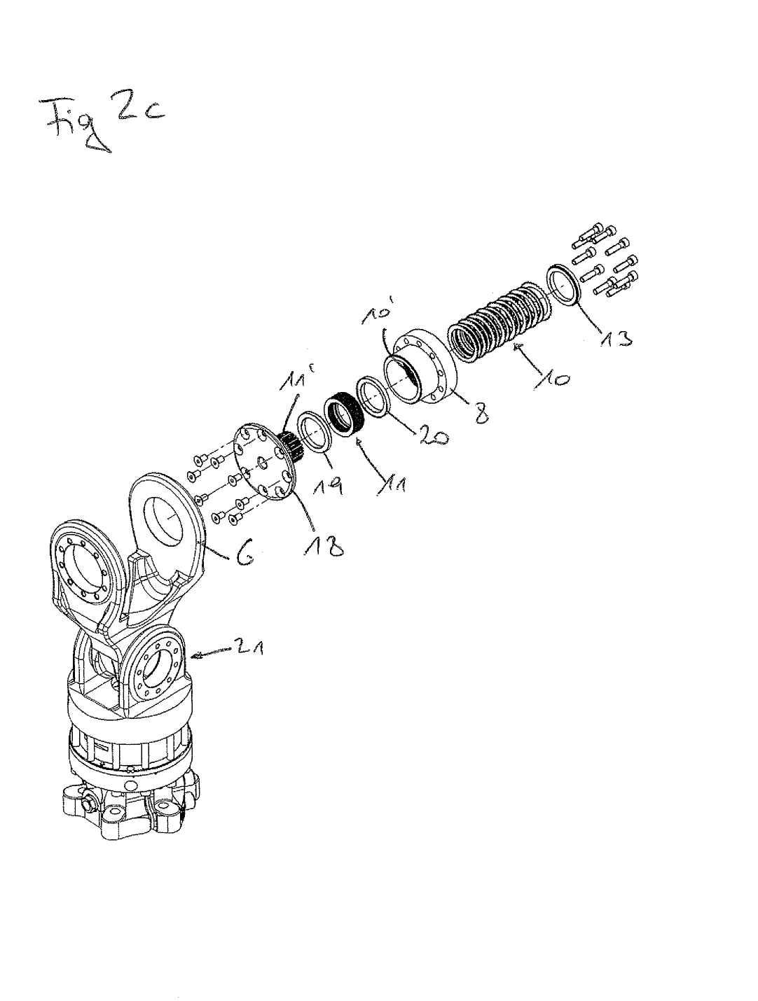

In the embodiment of FIG. 2, a swing brake 9 is provided only in the region of the pivot bearing 5. As also in the version of FIG. 1, the bearing pin 8 has a recess 15 in which both the plurality 10, 11 of disc-like brake elements and the plurality 12 of disc springs are arranged. In contrast to the version of FIG. 1, however, the plurality 10, 11 of disc-like brake elements are located outside the pivot bearing formed by the flaps 6, 7 (outside the region L). On the other hand, the plurality 12 of disc springs are arranged completely inside the pivot bearing 5.

When viewed in the direction of the axis of rotation x, the plurality 12 of disc springs and the plurality 10, 11 of disc-like brake elements are arranged in alignment one behind the other (as in FIG. 1).

The first portion 10 of disc-like brake elements from the plurality 10, 11 of disc-like brake elements is secured to the bearing pin 8 by means of a complementary toothed arrangement 10′ (see FIG. 2c). The second portion 11 of disc-like brake elements of the plurality 10, 11 of disc-like brake elements is secured to the cover 18 by means of a complementary toothed arrangement 11′.

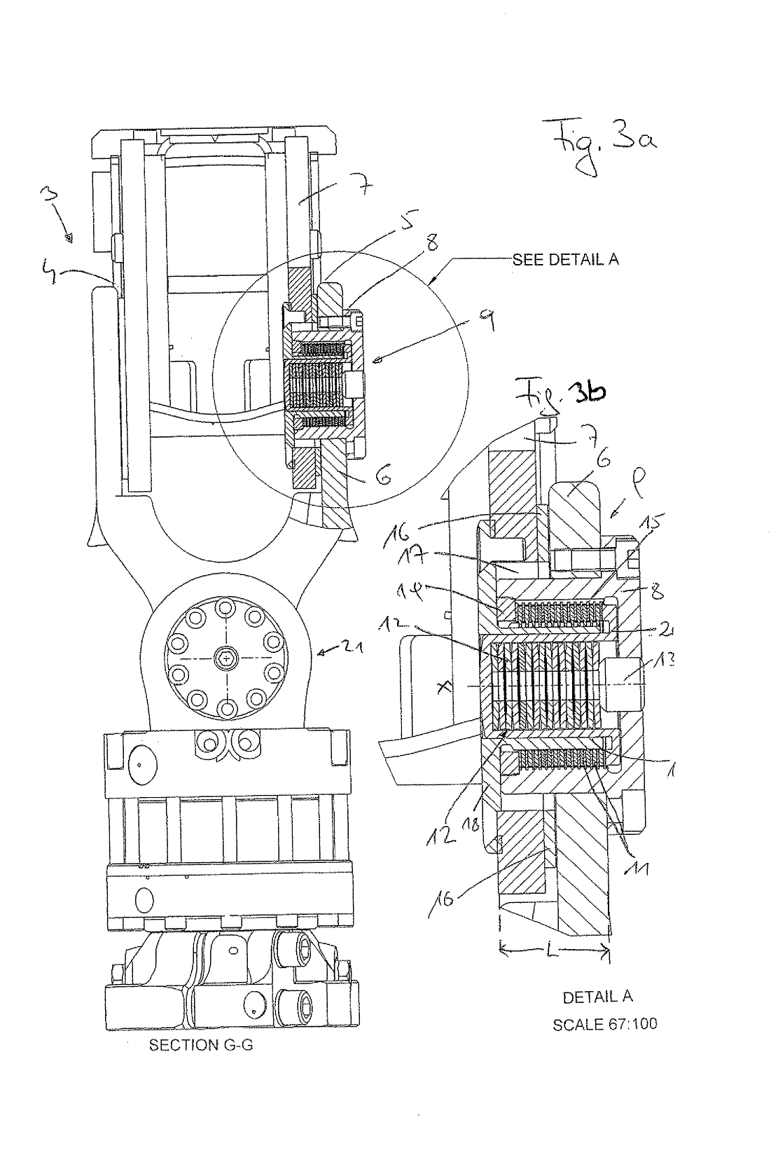

In the version of FIG. 3, a particularly space-saving swing brake 9 is shown. The bearing pin 8 again has a recess 15 in which both the plurality 10, 11 of disc-like brake elements and the plurality 12 of disc springs are arranged. In contrast to the previously discussed versions, however, the plurality 10, 11 of disc-like brake elements themselves have a recess 14, the plurality 12 of disc springs being arranged inside this recess 14. The plurality 12 of disc springs is arranged in the component 20 which is constructed to have a pot-like form and which belongs to the clamping device. Both the plurality 10, 11 of disc-like brake elements and the plurality 12 of disc springs are located in the pivot bearing 5 (region L).

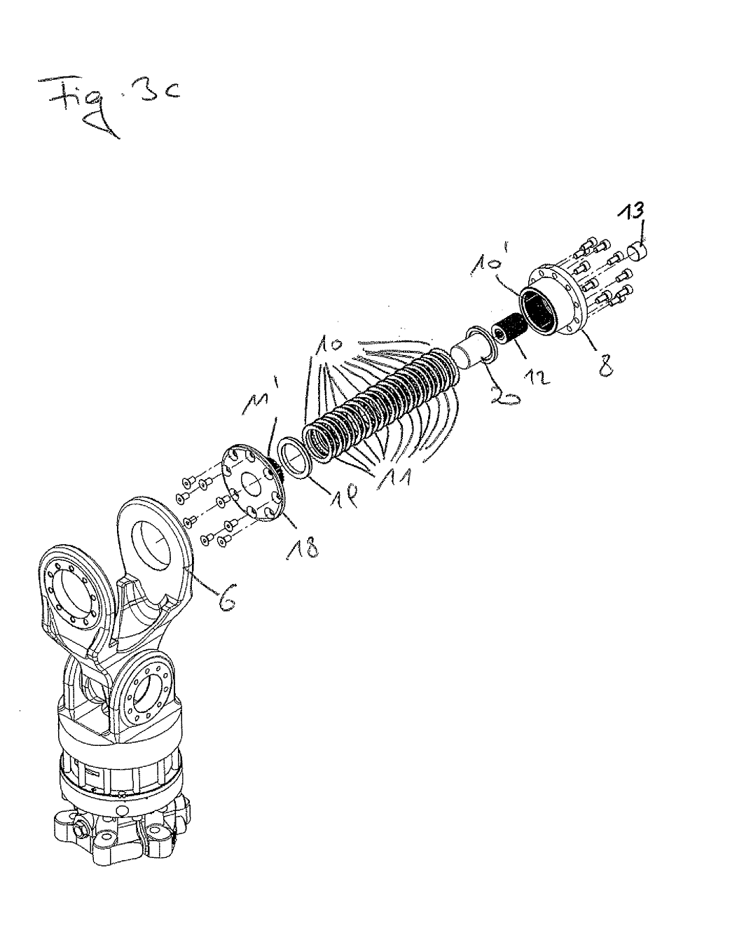

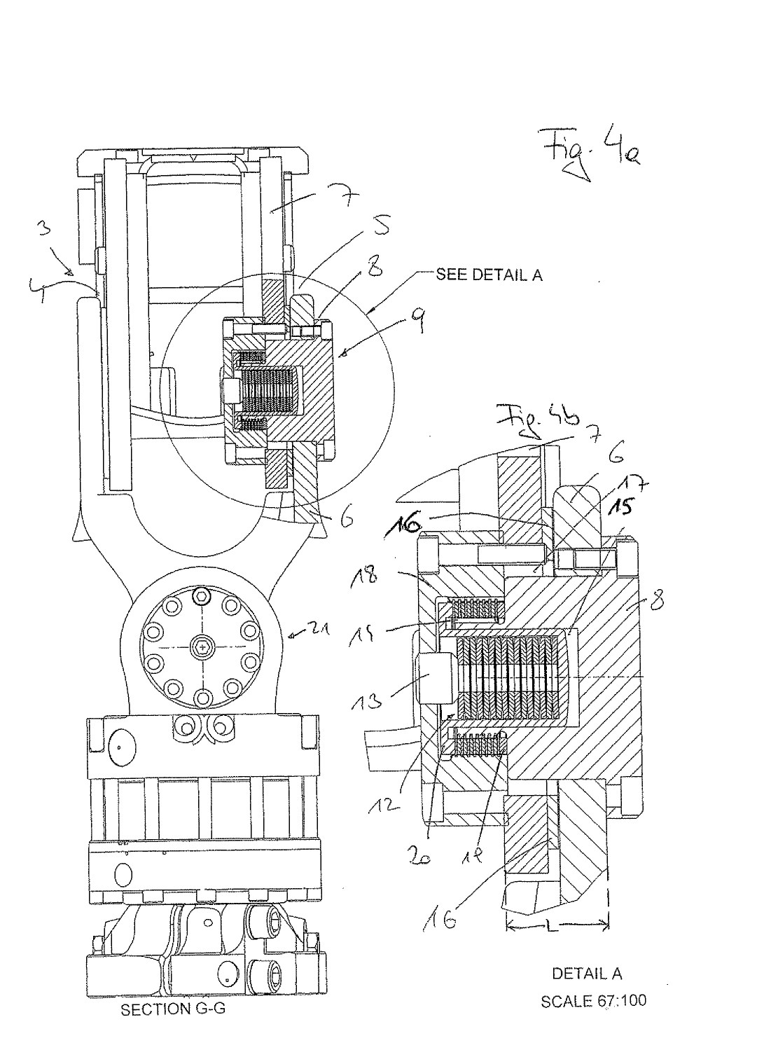

In the version of FIG. 4, the plurality 10, 11 of disc-like brake elements also have a recess 14 in which the plurality 12 of disc springs is partially received. In this embodiment, the bearing pin 8 also has a recess 15 but it serves only to receive the plurality 12 of disc springs. The plurality 10, 11 of disc-like brake elements is located in this instance outside the bearing pin 8. In this embodiment, the bearing pin 8 has a complementary toothed arrangement 11′ for the second portion 11 of disc-like brake elements from the plurality 10, 11 of disc-like brake elements. The complementary toothed arrangement 10′ for the disc-like brake elements of first portion 10 of the plurality 10, 11 of disc-like brake elements is arranged in the cover 18 (cannot be seen in FIG. 4d).

Unlike the illustration in FIGS. 1 to 4, the swing brake 9 could also be arranged in the pivot joint 21.

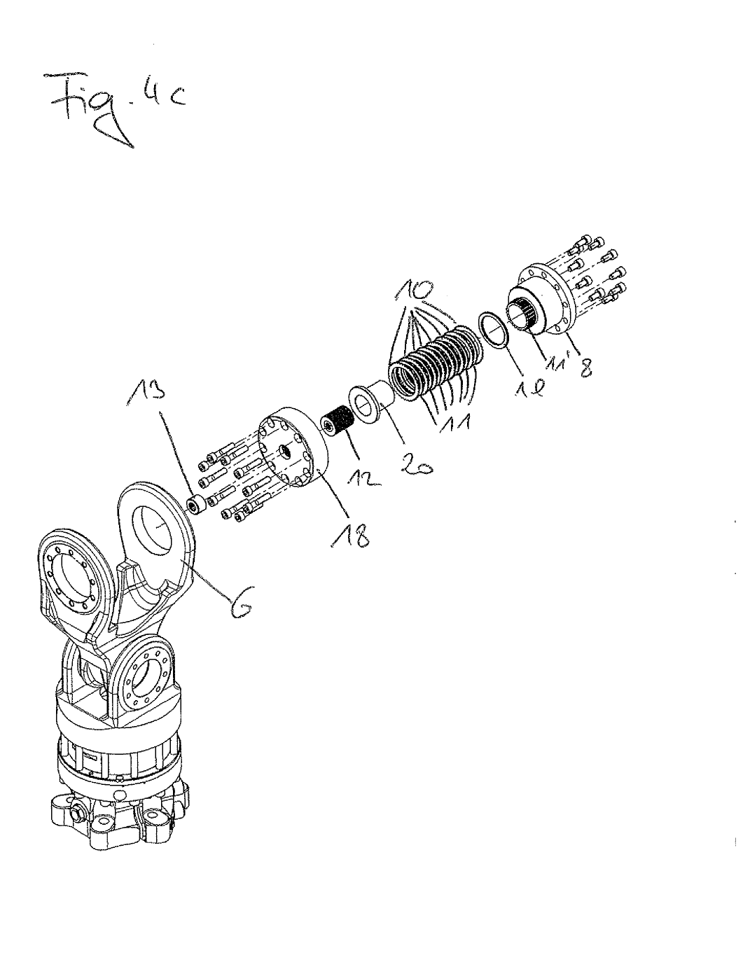

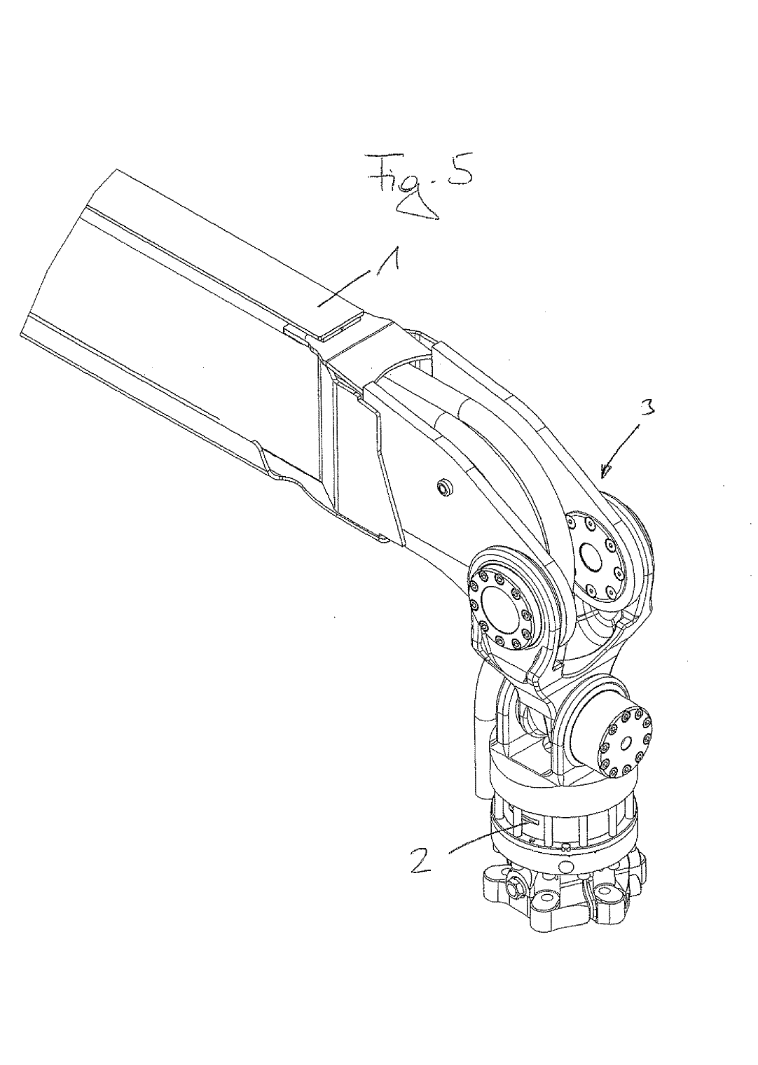

FIG. 5 illustrates a crane arm 1 having a pivot joint arrangement according to the invention.

FIG. 6 again shows the arrangement of FIG. 5 but with an operating device which is secured to the securing device 2 in the form of a forestry type processing device (this is illustrated only by way of example and other operating devices could naturally also be provided).

In general, the measures taught in the individual embodiments could also be used in any combination in the other embodiments.

1. Pivot joint arrangement for a crane arm having a securing device for operating devices, having:
a pivot joint which has, along the axis of rotation thereof, two spaced-apart pivot bearings, at least one of the two pivot bearings having at least two flaps and a bearing pin, of which one flap is connectable to the crane arm and the other flap is connectable to the securing device and the bearing pin being connected in a rotationally secure manner to one of the two flaps and rotating relative to the other of the two flaps,
and having at least one swing brake in order to brake or damp an oscillation of the operating device on the crane arm, the swing brake having a plurality of disc-like brake elements,
characterised in that
disc-like brake elements of a first portion of the plurality of disc-like brake elements have an outer profile at the outer peripheral edge thereof and
disc-like brake elements of a second portion of the plurality of disc-like brake elements have an inner profile at the inner peripheral edge thereof and
the first portion or second portion of disc-like brake elements is secured to the bearing pin in a positive-locking manner by means of a complementary profile, and
the other portion of disc-like brake elements is connected in a positive-locking manner by means of a complementary profile to that flap relative to which the bearing pin rotates.

2. Pivot joint arrangement according to claim 1, characterised in that the plurality of disc-like brake elements are arranged at least partially, preferably completely, in the pivot bearing.

3. Pivot joint arrangement according to claim 1, characterised in that there is provided an adjustable clamping device by means of which the plurality of disc-like brake elements are pressed together with an adjustable compressing force.

4. Pivot joint arrangement according to claim 3, characterised in that the adjustable clamping device has a plurality of disc springs and a screw mechanism for pressing together the plurality of disc springs.

5. Pivot joint arrangement according to claim 3, characterised in that the plurality of disc-like brake elements have a recess and the clamping device is arranged at least partially, preferably completely, inside the recess.

6. Pivot joint arrangement according to claim 3, characterised in that, when viewed in the direction of the axis of rotation of the pivot bearing, the plurality of disc-like brake elements and the clamping device are arranged one behind the other—and preferably in alignment relative to the axis of rotation of the pivot bearing.

7. Pivot joint arrangement according to claim 1, characterised in that the bearing pin has a recess and the plurality of disc-like brake elements are arranged at least partially, preferably completely, in the recess.

8. Pivot joint arrangement according to claim 3, characterised in that the bearing pin has a recess and the clamping device is arranged at least partially, preferably completely, in the recess.

9. Pivot joint arrangement according to claim 1, characterised in that both pivot bearings of the pivot joint are provided with—preferably identically constructed—swing brakes.

10. Pivot joint arrangement according to claim 1, characterised in that the outer profile, the inner profile and the complementary profiles are constructed as a toothed arrangement or with a multi-sided profile.

11. Crane having a pivot joint arrangement according to claim 1.

12. Vehicle having a crane according to claim 11.
